(19) United States
(12) Patent Application Publication
(10) Pub. No.: US 2025/0099874 A1
(43) Pub. Date: Mar. 27, 2025

(54) WATER-BASED DEMULSIFIER FORMULATION WITH ENHANCED CORROSION INHIBITION PROPERTY

(71) Applicant: Baker Hughes Oilfield Operations LLC, Houston, TX (US)

(72) Inventors: Jiangzhong Yang, Houston, TX (US); Enirco Nadres, Houston, TX (US); Bradley G. Harrell, Pearland, TX (US); Joseph J. Arensdorf, Conroe, TX (US); Lirio Quintero, Houston, TX (US)

(73) Assignee: Baker Hughes Oilfield Operations LLC, Houston, TX (US)

(21) Appl. No.: 18/373,206

(22) Filed: Sep. 26, 2023

(51) Int. Cl. B01D 17/04; C08L 71/10

(52) U.S. Cl. CPC B01D 17/047; C08L 71/10; C08L 2205/025; C08L 2666/66

(57) ABSTRACT

A water-based demulsifier includes two or more demulsifying resins, a surfactant, a hydrophilic linker, and a base solvent, which is water. In various embodiments, the two or more demulsifying resins include acid-catalyzed alkoxylated alkylphenol resins, base-catalyzed alkoxylated alkylphenol resins, polyol resins, and diepoxide resins. In one aspect, a method of using a water-based demulsifier with a desalter includes the steps of providing the water-based demulsifier and applying it at the desalter, where the water-based demulsifier includes an acid-catalyzed alkoxylated alkylphenol resin, a base-catalyzed alkoxylated alkylphenol resin, a surfactant, a hydrophilic linker, and a base solvent. In yet another aspect, a water-based demulsifier includes two or more demulsifying resins, a surfactant, a hydrophilic linker, and water as a base solvent, where the hydrophilic linker includes a C3-C18 branched linker, which may be a branched alkyl alcohol, a branched glycol, or a branched alkyl glycerin.

### FIELD OF THE INVENTION

The present application is generally directed at water-based demulsifiers and methods for using such water-based demulsifiers.

### BACKGROUND

Crude oil often contains water, inorganic salts, suspended solids, and water-soluble trace metals. To reduce corrosion, plugging, and fouling of equipment and to prevent poisoning the catalysts in processing units, the crude oil in refineries must be treated to remove these contaminants, namely water and associated salts. This process is called “desalting”.

Contaminants are removed from the crude oil in a desalter vessel. Before entering the desalter, crude oil is mixed with fresh water (or “wash water”) to form an emulsion. This emulsion mixes the wash water with contaminants in the oil, such that unwanted contaminants will partition into the emulsified water.

Demulsifiers are injected to break the emulsion into oil and water phases. Demulsifiers facilitate the flocculation of oil droplets and coalescence of water droplets, such that oil-water separation occurs within the time frame required for refinery throughput constraints. Current demulsifier formulations are typically high in carbon-rich aromatic solvents, which emit carbon dioxide and are expensive.

The increased emphasis on addressing environmental concerns is motivating the oil and gas industry to seek chemistries that are more environmentally friendly. To lower both carbon emissions and cost, it is desirable to replace the aromatic solvents in current demulsifiers with water as the base solvent. Unfortunately, simply replacing aromatic solvents with water causes severe corrosion issues —both for general and pitting corrosion—that are almost impossible to treat with existing corrosion inhibitors. Pitting corrosion is particularly problematic because it is more difficult to find, predict, and design against than general corrosion. Even a small pit resulting in minimal overall metal loss can lead to large-scale equipment failure. Merely replacing aromatic solvents with water also leads to instability and separation at elevated temperatures, such as those encountered in the field when demulsifiers are stored under the sun.

There is, therefore, a need for cost-effective and environmentally friendly treatments for use in the oil and gas industry. The present disclosure is directed at these and other deficiencies in the prior art.

### SUMMARY OF THE INVENTION

The inventive concepts disclosed are generally directed to a water-based demulsifier formulation. In one aspect, a water-based demulsifier is disclosed, in which the water-based demulsifier includes an acid-catalyzed alkoxylated alkylphenol resin, a base-catalyzed alkoxylated alkylphenol resin, a surfactant, a hydrophilic linker, and water as a base solvent. The water-based demulsifier optionally includes a polyol resin or a diepoxide resin.

In another aspect, a method of using a water-based demulsifier in a desalting process includes the steps of providing the water-based demulsifier and applying the water-based demulsifier at the desalter. The water-based demulsifier includes an acid-catalyzed alkoxylated alkylphenol resin, a base-catalyzed alkoxylated alkylphenol resin, a surfactant, a hydrophilic linker, and water as a base solvent.

In yet another aspect, a water-based demulsifier includes two or more demulsifying resins, a surfactant, a hydrophilic linker, and water as a base solvent. The two or more demulsifying resins may include acid-catalyzed alkoxylated alkylphenol resins, base-catalyzed alkoxylated resins, polyol resins, and diepoxide resins. The hydrophilic linker includes a C3-C18 branched linker, which may be a branched alkyl alcohol, a branched glycol, or a branched alkyl glycerin.

### DETAILED DESCRIPTION

It has been discovered that the homogeneity of demulsifiers in water can be improved with the use of hydrophilic linkers and surfactants. A water-based demulsifier may be used to overcome the severe corrosion, including pitting corrosion, on low-metallurgy carbon steel that is commonly associated with the use of water in place of aromatic solvent in demulsification formulations. The water-based demulsifier also presents improved stability and separation at elevated temperatures compared to other demulsifier formulations with water. The use of water, as opposed to aromatic solvent, as a base solvent in the water-based demulsifier effectively reduces the carbon footprint of the demulsification process and cuts cost almost in half.

According to various embodiments disclosed herein, the water-based demulsifier includes two or more demulsifying resins, a surfactant, a hydrophilic linker, and water as a base solvent. The two or more demulsifying resins include, in various embodiments, acid-catalyzed alkyoxylated alkylphenol resins, base-catalyzed alkyoxylated alkylphenol resins,

Suitable surfactants include C8-C24 alcohol ethoxylates, alkyl diphenyl oxide disulfonates, biosurfactants, and combinations thereof. Biosurfactants, if present, may include glucosides, rhamnolipids, alkylpolyglycosides including but not limited to alkyl polyglucoside carboxylate, sophorolipids, licithins, lipopeptides such as surfactin, betaine (C₅H₁₁NO₂), emulsan, and combinations of the same.

The hydrophilic linker within the water-based scavenger may include branched linkers and combinations of branched and linear linkers. In some embodiments, the hydrophilic linker may have one or more branched linkers, where suitable branched linkers include branched C3-C18 alkyl alcohols, branched C3-C18 glycols, and branched C3-C18 alkyl glycerins. These branched linkers provide stability and improve viscosity of the water-based scavengers due to a greater amount of interaction at the oil/water interface. Suitable linear linkers include linear C1-C18 alkyl glycols; linear C1-C18 alkyl alcohols; linear C1-C18 alkyl glycerins; polymers including but not limited to polyethylene glycol (PEG), polypropylene glycol (PPG), block copolymers with PEG and/or PPG, and random copolymers with PEG and/or PPG; and combinations of the same.

In several embodiments, the water-based demulsifier includes an acid-catalyzed alkyoxylated alkylphenol resin, a base-catalyzed alkyoxylated alkylphenol resin, or both. The acid-catalyzed alkyoxylated alkylphenol resin and the base-catalyzed alkyoxylated alkylphenol resin both may include a mixture of carbon chains with a variety of chain lengths. In some embodiments, the chains in the acid-catalyzed alkoxylated alkylphenol resin may include C4-C12 alkyl chains. The base-catalyzed alkoxylated alkylphenol resin may likewise include C4-C12 alkyl chains in some embodiments. Both the acid-catalyzed and base-catalyzed resins may include predominantly C9-C12 chains in the respective mixtures.

In one embodiment, the water-based demulsifier includes between about 5 wt. % and about 40 wt. % acid-catalyzed alkoxylated alkylphenol resin, between about 5 wt. % to about 40 wt. % base-catalyzed alkoxylated alkylphenol resin, between about 1 wt. % to about 10 wt. % surfactant, between about 1 wt. % to about 20 wt. % hydrophilic linker, and between about 20 wt. % to about 60 wt. % base solvent.

In another embodiment, the water-based demulsifier includes between about 9 wt. % to about 15 wt. % acid-catalyzed alkoxylated alkylphenol resin, between about 9 wt. % to about 20 wt. % base-catalyzed alkoxylated alkylphenol resin, between about 2 wt. % to about 6 wt. % surfactant, between about 5 wt. % to about 10 wt. % branched linker, between about 5 wt. % to about 10 wt. % linear linker, and between about 40 wt. % to about 60 wt. % base solvent.

In yet another embodiment, the water-based demulsifier includes about 12 wt. % acid-catalyzed alkoxylated alkylphenol resin, about 15 wt. % base-catalyzed alkoxylated alkylphenol resin, about 5 wt. % surfactant, about 9 wt. % branched linker, about 6 wt. % linear linker, and about 53 wt. % base solvent.

In several embodiments, the water-based demulsifier includes a polyol resin. Inclusion of the polyol resin in the water-based demulsifier is useful with heavier crude oils that may contain more solids. By way of non-limiting example, the polyol resin component may include alkoxylated polyol resins derived from one or more of the following: synthetic glycols, naturally produced glycols, polyamines, polycarboxylic acids, polyalcohols with multiple hydroxyl functional groups, amino acids, and carbohydrates. It will be appreciated that the polyol resins component may include one or more polyol resins derivatized by C2-C5 alkylene oxides or alkylene carbonates. As defined here, “polyol resins” are free of diepoxide or phenol resins.

In one embodiment, the water-based demulsifier includes between about 5 wt. % and about 40 wt. % acid-catalyzed alkoxylated alkylphenol resin, between about 5 wt. % to about 40 wt. % base-catalyzed alkoxylated alkylphenol resin, between about 1 wt. % to about 30 wt. % polyol resin, between about 1 wt. % to about 10 wt. % surfactant, between about 1 wt. % to about 20 wt. % hydrophilic linker, and between about 20 wt. % to about 60 wt. % base solvent.

In another embodiment, the water-based demulsifier includes between about 9 wt. % to about 15 wt. % acid-catalyzed alkoxylated alkylphenol resin, between about 9 wt. % to about 20 wt. % base-catalyzed alkoxylated alkylphenol resin, between about 16 wt. % to about 30 wt. % polyol resin, between about 2 wt. % to about 6 wt. % surfactant, between about 1 wt. % to about 20 wt. % hydrophilic linker, and between about 40 wt. % to about 60 wt. % base solvent.

The water-based demulsifier of several embodiments includes a diepoxide resin. Suitable diepoxide resins are obtained through crosslinking of at least one diepoxide with one or more polyglycols or polyols.

In one embodiment, the diepoxide is present in an amount between about 8 wt. % to about 15 wt. % of the water-based demulsifier. For example, the water-based demulsifier may include between about 9 wt. % to about 15 wt. % acid-catalyzed alkoxylated alkylphenol resin, between about 9 wt. % to about 20 wt. % base-catalyzed alkoxylated alkylphenol resin, between about 8 wt. % to about 15 wt. % of the water-based demulsifier, between about 2 wt. % to about 6 wt. % surfactant, between about 1 wt. % to about 20 wt. % hydrophilic linker, and between about 40 wt. % to about 60 wt. % base solvent.

In some embodiments, the water-based demulsifier also includes a wetting agent. The wetting agent may be present in an amount between about 1 wt. % to about 10 wt. % in the water-based demulsifier. In one embodiment, the water-based demulsifier includes about 5 wt. % wetting agent.

It will be understood that, as used herein, a range of X wt. % to Y wt. % will be interpreted to include the disclosure of each discrete integer value between X and Y (e.g., X, X+1, X+2. . . . Y−1, Y).

The water-based demulsifier may be used in a desalting process to break the emulsion of crude oil and wash water. In some embodiments, the water-based demulsifier may be applied at a desalter by injecting a treatment of the water-based demulsifier into the crude oil before it enters the desalter. Injection into the oil phase may be desirable where the crude is relatively easy to process. In certain embodiments, the water-based demulsifier may instead be injected into the wash water before it enters the desalter. In other embodiments, the water-based demulsifier may be injected into both the crude oil and the wash water. In yet other embodiments, the water-based demulsifier may be injected into the wash water as an adjunct to a different demulsifier injected into the oil phase, in order to enhance overall performance through the use of two different products. The addition of the water-based demulsifier into the water phase may be desirable where the crude is not as easy to process.

### EXAMPLE I

Possible blends for the water-based demulsifier were formulated and screened using an electrostatic desalting dehydration apparatus (EDDA) test method to simulate the desalting process. The tested water-based demulsifiers include those with the following compositions of the same acid catalyzed resin, base catalyzed resin, surfactant, branched linker, and linear linker:

TABLE 1
(wt. %)

| DEMULSIFIER | A | B | C | D | E |
|---|---|---|---|---|---|
| Acid catalyzed resin | 12 | 12 | 12 | 12 | 12 |
| Base catalyzed resin | 15 | 15 | 15 | 15 | 15 |
| Surfactant | 4 | 4.5 | 5 | 5.5 | 6 |
| Branched linker | 9.75 | 9.5 | 9.25 | 9 | 8.75 |
| Linear linker | 6.25 | 6 | 5.75 | 5.5 | 5.25 |
| Base solvent (water) | 53 | 53 | 53 | 53 | 53 |

To perform the EDDA tests, West Texas Intermediate (WTI) crude oil was added to a Waring blender, followed by 5% deionized wash water to bring up the total volume. The crude mixture was mixed at 60% speed for four (4) minutes on a variac mixer. The crude mixture was then poured into EDDA tubes to just below the 100 mL line, and the tubes were placed in an EDDA heating block, which was heated to 120° C. For each test tube, except for those designated as blank samples, 6 ppm demulsifier was added. A screw top electrode cap was then placed on each of the EDDA tubes, and the samples were heated for approximately twenty-five (25) minutes. The tubes were subsequently shaken 100-200 times and returned to the heating block for five (5) minutes. An electrode cover was placed over the EDDA tubes and locked into place with good contact between the cover and the electrode caps. The electrodes ran at 1500 volts for five (5) minutes before the tubes were pulled out. At this time, the percent water drop was recorded for each tube. The electrode cover was replaced over the EDDA tubes, and the subsequent steps repeated until the desired total residence time was achieved.

### EXAMPLE II

A dehydration test was performed on certain samples from Example I to observe the amount of water and/or solids that broke out of each sample, record any emulsions, and obtain basic sediment and water (BS&W) data. The performance of these water-based demulsifiers from Example I was compared against that of three hydrocarbon-based products, designated as Demulsifiers F, G, and H. For each sample in this test, except for a blank sample, a 12.5 mL centrifuge tube was filled to the 50% mark with xylene, followed by 5.8 mL of dehydrated WTI crude with 4% wash water containing one of Demulsifier A, B, F, G, and H. The centrifuge tubes were each centrifuged at 2000 rpm for four (4) minutes before observing the samples.

As shown in the table below, approximately the same amount of water (in mL) broke out over time in each of Demulsifiers A, B, F, G, and H. Each sample experienced over twice the amount of water breaking out as the blank sample, which had received no demulsifier.

TABLE 2
(Water broke out in mL)

| | 0 minutes | 5 minutes | 10 minutes | 15 minutes |
|---|---|---|---|---|
| Blank | 0.3 | 0.5 | 1.2 | 2 |
| Demulsifier A | 1 | 2.6 | 3.5 | 4 |
| Demulsifier B | 1 | 2.6 | 3.5 | 4 |
| Demulsifier F | 1 | 2.6 | 3.5 | 4 |
| Demulsifier G | 1 | 2.6 | 3.5 | 4 |
| Demulsifier H | 1 | 2.6 | 3.5 | 4 |

The interface and brine were also observed for each test tube. Both the sample with Demulsifier A and the blank sample had a 2.5 mL emulsion. The remaining samples showed a 0.5 mL emulsion and were slightly clear. Demulsifiers B, F, G, and H were therefore better at breaking the emulsion than Demulsifier A.

Each sample, including the blank sample, demonstrated only trace BS&W.

### EXAMPLE III

Additional tests were performed to compare the performance of certain water-based demulsifiers from Example I (specifically, Demulsifier B) against a hydrocarbon-based product with the same activity and hydrocarbon-based Demulsifier F. Samples were prepared and subjected to the EDDA test method as in Example I, with the following changes. The WTI crude was replaced with a 3:1 mixture of WTI crude and West Texas Sour crude (WTI:WTS), followed by 5% deionized wash water rather than 4%. Further, 8 ppm of demulsifier, rather than 6 ppm, was added to each test tube except for the blank sample. The dehydration test of Example II was performed on each sample with the following results.

As shown below, approximately the same amount of water (in mL) broke out over time for both Demulsifier B and F. The Demulsifier B sample experienced a greater amount of water breaking out than the existing hydrocarbon-based product and the same amount of water breaking out as the Demulsifier F sample. The amount of water broken out over time for Demulsifiers B and F also exceeded the amounts observed with the same demulsifiers in Example II. Further, both the Demulsifier B and F samples experienced over triple the amount of water breaking out as the blank sample, which had received no demulsifier.

TABLE 3
(Water broke out in mL)

| | 0 minutes | 5 minutes | 10 minutes | 15 minutes |
|---|---|---|---|---|
| Blank | 0.4 | 0.6 | 0.6 | 1.4 |
| Hydrocarbon- | 2.4 | 3 | 3.2 | 3 |
| based product | | | | |
| Demulsifier B | 2.6 | 3.7 | 4 | 4.2 |
| Demulsifier F | 2.6 | 3.7 | 4 | 4.2 |

The blank sample contained a 3.5 mL emulsion and was slightly cloudy. The samples with Demulsifier B and F each presented a 0.5 mL emulsion and were slightly cloudy. In comparison, the existing hydrocarbon-based product was also slightly cloudy but showed only a 2 mL emulsion. The sample with water-based Demulsifier B was, therefore, much better than the existing hydrocarbon-based product at breaking the emulsion into oil and water phases. Demulsifier B also had comparable performance to hydrocarbon-based Demulsifier F.

The samples with Demulsifier B and F demonstrated only trace BS&W. The existing hydrocarbon-based product and blank sample both showed 0.4% BS&W.

### EXAMPLE IV

Additional tests were performed to compare the performance of yet other water-based demulsifiers against a hydrocarbon-based product. The tested water-based demulsifiers include those with the following compositions of the same acid catalyzed resin, base catalyzed resin, surfactant, branched linker, and linear linker:

TABLE 4
(wt. %)

| DEMULSIFIER | I | J | K |
|---|---|---|---|
| Acid catalyzed resin | 11.4 | 11.4 | 11.4 |
| Base catalyzed resin | 14.25 | 14.25 | 14.25 |
| Alkoxylated polyol resin | — | 5.0 | — |
| Alkoxylated diepoxide resin | — | — | 5.0 |
| Surfactant | 4.3 | 4.3 | 4.3 |
| Branched linker | 9.0 | 9.0 | 9.0 |
| Linear linker | 5.7 | 5.7 | 5.7 |
| Wetting agent | 5.0 | | |
| Base solvent (water) | 50.35 | 50.4 | 50.4 |

The crude for these tests was a 65:35 mixture of Caspian crude oil and WTI crude (Caspian:WTI), and the crude was followed by 4.75% deionized wash water. 8 ppm of demulsifier was added to each test tube except for the blank sample. The dehydration test of Examples II and III was then performed on each sample with the following results.

As shown in Table 5, approximately the same amount of water (in mL) broke out over time for Demulsifier I and the hydrocarbon-based product. The Demulsifier J sample demonstrated less water breaking out than did Demulsifier J at most observed time intervals. Demulsifier K experienced even less water breaking out over time; however, this demulsifier still performed noticeably better than the blank.

TABLE 5
(Water broke out in mL)

| | 0 minutes | 5 minutes | 10 minutes | 15 minutes |
|---|---|---|---|---|
| Blank | 2 | 3 | 3 | 3.2 |
| Hydrocarbon- | 3 | 3.7 | 4.2 | 4.5 |
| based product | | | | |
| Demulsifier I | 3 | 3.7 | 4.2 | 4.5 |
| Demulsifier J | 2.6 | 3.7 | 4 | 4.2 |
| Demulsifier K | 2.7 | 3.2 | 3.5 | 3.7 |

The sample with water-based Demulsifier I was, therefore, most comparable to the existing hydrocarbon-based product in breaking the emulsion into oil and water phases.

The interface and brine of each sample were also observed. All samples had a slightly cloudy brine. The blank had a 1.5 mL emulsion, while the samples with the hydrocarbon-based product, Demulsifier J, and Demulsifier K all had a 0.5 mL emulsion. Demulsifier I, by contrast, showed only a trace emulsion. Demulsifier I was, therefore, the best at breaking the emulsion in this crude oil. It will be appreciated that Demulsifiers J and K may perform better than Demulsifier I in a different crude oil (e.g., a heavier crude that contains more solids).

Each sample, including the blank sample, demonstrated only trace BS&W.

In the foregoing specification, the invention has been described with reference to specific embodiments thereof. However, it will be evident that various modifications and changes can be made thereto without departing from the broader scope of the invention as set forth in the appended claims. Accordingly, the specification is to be regarded in an illustrative rather than a restrictive sense. For example, resins, hydrophilic linkers, surfactants, solvents, treatment procedures, proportions, dosages, temperatures, and amounts not specifically identified or described in this disclosure or not evaluated in a particular Example are still expected to be within the scope of this invention.

The present invention may suitably comprise, consist of, or consist essentially of the elements disclosed and may be practiced in the absence of an element not disclosed. As used herein, the singular forms “a,” “an,” and “the” are intended to include the plural forms as well, unless the context clearly indicates otherwise. As used herein, the term “about” in reference to a given parameter is inclusive of the stated value and has the meaning dictated by the context (e.g., it includes the degree of error associated with measurement of the given parameter, i.e., ±5% of the stated value). As used herein, the term “and/or” includes any and all combinations of one or more of the associated listed items. As used herein, the term “elevated temperatures” refers to a temperature range above about 35° C.

It is claimed:

1. A water-based demulsifier comprising:
an acid-catalyzed alkoxylated alkylphenol resin;
a base-catalyzed alkoxylated alkylphenol resin;
a surfactant;
a hydrophilic linker; and
a base solvent, wherein the base solvent is water.

2. The water-based demulsifier of claim 1, wherein the surfactant is selected from a group consisting of C8-C24 alcohol ethoxylates, alkyl diphenyl oxide disulfonates, biosurfactants, and combinations thereof.

3. The water-based demulsifier of claim 1, wherein the surfactant is a biosurfactant selected from the group consisting of glucosides, rhamnolipids, alkylpolyglycosides, sophorolipids, licithins, lipopeptides, betaine, emulsan, and combinations thereof.

4. The water-based demulsifier of claim 1, wherein the hydrophilic linker further comprises a C3-C18 branched linker selected from a group consisting of branched alkyl alcohols, branched glycols, branched alkyl glycerins, and combinations thereof.

5. The water-based demulsifier of claim 4, wherein the hydrophilic linker further comprises a C1-C18 linear linker selected from a group consisting of linear alkyl alcohols, linear glycols, linear alkyl glycerins, and combinations thereof.

6. The water-based demulsifier of claim 1 comprising:
between about 5 wt. % to about 40 wt. % acid-catalyzed alkoxylated alkylphenol resin;
between about 5 wt. % to about 40 wt. % base-catalyzed alkoxylated alkylphenol resin;
between about 1 wt. % to about 10 wt. % surfactant;
between about 1 wt. % to about 20 wt. % hydrophilic linker; and
between about 20 wt. % to about 60 wt. % base solvent.

7. The water-based demulsifier of claim 1 further comprising a polyol resin, wherein the polyol resin is an alkoxylated polyol resin derived from at least one of synthetic glycols, naturally produced glycols, polyamines, polycarboxylic acids, amino acids, and carbohydrates.

8. The water-based demulsifier of claim 7 comprising:
between about 5 wt. % to about 40 wt. % acid-catalyzed alkoxylated alkylphenol resin;
between about 5 wt. % to about 40 wt. % base-catalyzed alkoxylated alkylphenol resin;
between about 1 wt. % to about 30 wt. % polyol resin;
between about 1 wt. % to about 10 wt. % surfactant;
between about 1 wt. % to about 20 wt. % hydrophilic linker; and
between about 20 wt. % to about 60 wt. % base solvent.

9. The water-based demulsifier of claim 1 further comprising a diepoxide resin of one or more polyglycol or polyols.

10. The water-based demulsifier of claim 9 comprising:
between about 9 wt. % to about 15 wt. % acid-catalyzed alkoxylated alkylphenol resin;
between about 9 wt. % to about 20 wt. % base-catalyzed alkoxylated alkylphenol resin;
between about 8 wt. % to about 15 wt. % diepoxide resin;
between about 2 wt. % to about 6 wt. % surfactant;
between about 1 wt. % to about 20 wt. % hydrophilic linker; and
about 40 wt. % to about 60 wt. % base solvent.

11. A method of using a water-based demulsifier in a desalting process, the method comprising the steps of:
providing the water-based demulsifier, wherein the water-based demulsifier comprises:
an acid-catalyzed alkoxylated alkylphenol resin;
a base-catalyzed alkoxylated alkylphenol resin;
a surfactant;
a hydrophilic linker; and
a base solvent, wherein the base solvent is water; and
applying the water-based demulsifier at a desalter.

12. The method of claim 11, wherein the step of applying the water-based demulsifier at the desalter comprises injecting the water-based demulsifier into a crude oil stream before it enters the desalter.

13. The method of claim 11, wherein the step of applying the water-based demulsifier at the desalter comprises injecting the water-based demulsifier into a wash water stream before it enters the desalter.

14. The method of claim 12, wherein the step of applying the water-based demulsifier at the desalter further comprises injecting the water-based demulsifier into a wash water stream before it enters the desalter.

15. A water-based demulsifier comprising:
two or more demulsifying resins selected from the group consisting of acid-catalyzed alkoxylated alkylphenol resins, base-catalyzed alkoxylated alkylphenol resins, polyol resins, and diepoxide resins;
a surfactant;
a hydrophilic linker comprising a C3-C18 branched linker selected from a group consisting of branched alkyl alcohols, branched glycols, branched alkyl glycerins, and combinations thereof; and
a base solvent, wherein the base solvent is water.

16. The water-based demulsifier of claim 15, wherein the hydrophilic linker further comprises a C1-C18 linear linker selected from a group consisting of linear alkyl alcohols, linear alkyl glycols, linear alkyl glycerins, polyols like PEG, PPG, block or random co-PEG or PPG, or the combinations and combinations thereof.

17. The water-based demulsifier of claim 15, wherein one of the demulsifying resins is a polyol resin selected from the group consisting of alkoxylated polyol resins derived from at least one of synthetic glycols, naturally produced glycols, polyamines, polycarboxylic acids, amino acids, and carbohydrates.

18. The water-based demulsifier of claim 15, wherein one of the demulsifying resins is a diepoxide resin of one or more polyglycol or polyols.

19. The water-based demulsifier of claim 15, wherein one of the demulsifying resins is an acid-catalyzed alkoxylated alkylphenol resin comprising C4-C12 alkyl chains.

20. The water-based demulsifier of claim 15, wherein one of the demulsifying resins is a base-catalyzed alkoxylated alkylphenol resin comprising C4-C12 alkyl chains
